(19) United States
(12) Patent Application Publication
(10) Pub. No.: US 2013/0309586 A1
(43) Pub. Date: Nov. 21, 2013

(54) Expansion Tank for a Liquid Fluid and Ion Exchanger of an Expansion Tank

(71) Applicant: MANN+HUMMEL GMBH, Ludwigsburg (DE)

(72) Inventors: Markus Beylich, Ludwigsburg (DE); Michael Fasold, Auenwald (DE); Jawad Nouri, Marbach (DE)

(73) Assignee: MANN+HUMMEL GMBH, Ludwigsburg (DE)

(21) Appl. No.: 13/948,773

(22) Filed: Jul. 23, 2013

Related U.S. Application Data
(63) Continuation of application No. PCT/EP2012/051523, filed on Jan. 31, 2012.

(30) Foreign Application Priority Data
Jan. 31, 2011 (DE) 10 2011 009 917.4

(51) Int. Cl. H01M 8/04

(52) U.S. Cl. CPC H01M 8/04044
USPC 429/410

(57) ABSTRACT

An expansion tank (10) for liquid fluid includes at least one fluid inlet (36) and at least one fluid outlet (48). An ion exchanger (25) for processing the fluid includes an ion exchanger tank (26) that includes at least one inlet (41) and at least one outlet (43) for processed fluid. In the ion exchanger tank (26), a granular ion-exchange medium (27) is arranged between the inlet (41) and the outlet (43). The ion exchanger tank (26) is replaceably arranged in the expansion tank (10). The inlet (41) corresponds to the fluid inlet (36) and the outlet (43) corresponds to the fluid outlet (48). The ion exchanger tank (26) has a flexible casing.

### CROSS REFERENCE TO RELATED APPLICATIONS

This application is U.S. bypass continuation of international patent application no. PCT/EP2012/051523, filed Jan. 31, 2012 designating the United States of America, the entire disclosure of which is incorporated herein by reference. PCT/EP2012/051523 claims priority to German patent application no. 10 2011 009 917.4, filed Jan. 31, 2011.

### TECHNICAL FIELD

The invention concerns an expansion tank for liquid fluid, in particular cooling fluid of a cooling device of a functional system, in particular of a fuel cell system, in particular of a motor vehicle, comprising at least one fluid inlet and at least one fluid outlet for the fluid and comprising an ion exchanger for processing the fluid with an ion exchanger container that has at least one inlet for the fluid to be processed and at least one outlet for the processed fluid and in which a granular ion exchange medium is arranged in the flow between the inlet and the outlet, and wherein the ion exchange container is arranged in the expansion tank so as to be exchangeable and the inlet corresponds with the fluid inlet and the outlet corresponds with the fluid outlet.

Moreover, the invention concerns an ion exchanger of an expansion tank for liquid fluid, in particular, cooling fluid of a cooling device of a functional system, in particular of a fuel cell system, in particular of a motor vehicle, for processing the fluid, comprising an ion exchange container that has at least one inlet for the fluid to be processed and at least one outlet for the processed fluid and in which the granular ion exchange medium is arranged in the flow between the inlet and the outlet and that is arranged exchangeably in the expansion tank such that the inlet corresponds with a fluid inlet of the expansion tank and the outlet corresponds with a fluid outlet of the expansion tank.

### BACKGROUND

DE 10 2009 012 379 A1 discloses a cooling medium tank for a cooling medium system of a fuel cell stack. The cooling medium tank comprises a cooling medium inlet and a cooling medium outlet. An ion exchange cartridge is positioned on a bottom part of the cooling medium tank in its own chamber of the cooling medium tank, adjacent to the cooling medium inlet. The ion exchange cartridge comprises a housing in which an ion exchange resin is arranged. The ion exchange cartridge comprises at least one fluid-permeable outlet port that is formed in the housing. The outlet port enables fluid communication with the cooling medium outlet. The housing of the ion exchange cartridge has moreover an inlet for fluid communication with the cooling medium inlet. The cooling medium flows for processing through the ion exchange cartridge and thus through the ion exchange resin from the inlet, from bottom to top, to the outlet port. The ion exchange cartridge is comprised of a rigid material and is therefore rigid and non-deformable. The ion exchange resin is loosely arranged within the ion exchange cartridge. The loose arrangement of the ion exchange resin in the rigid ion exchange cartridge enables formation of preferred flow paths by the cooling medium passing through. Such preferred flow paths are undesirable because only a portion of the ion exchange medium is flowed through and develops its effect. Accordingly, the total capacity of the ion exchanger with regard to processing of the cooling medium is reduced as a whole. Moreover, the service life of the ion exchange cartridge is extended.

The invention has the object to configure an expansion tank for liquid fluid and an ion exchanger of the aforementioned kind in such a way that it can be realized in a simple and space-saving way, has an optimal efficiency with regard to processing of the fluid, and has a service life as long as possible.

### SUMMARY OF THE INVENTION

This object is solved according to the invention in that the ion exchange container has a flexible envelope.

According to the invention, the ion exchange container has a flexible envelope and is therefore changeable with respect to its shape in an easy way. For example, it can be compressed simply from the exterior by applying an appropriate force and the ion exchange medium contained in the ion exchange container can be compressed. Compression of the ion exchange medium counteracts the undesirable formation of preferred flow channels. Accordingly, the service life of the ion exchanger is extended. Moreover, the efficiency with regard to processing of the fluid is improved. The flexible ion exchange container can also be adapted optimally with regard to the available mounting space in a simple way. An ion exchange container in one embodiment can thus be used in different expansion tanks. In this way, the required component variety is reduced. Incidentally, an ion exchange container of one embodiment can be filled, as needed, with different quantities of ion exchange material. Voids within the ion exchange container can be compressed simply by compression of the ion exchange container. In this way, ion exchangers with different capacities can be realized by means of an ion exchange container of a single size.

According to an advantageous embodiment, at least one compression device, in particular with at least one elastic element, can be provided for compression of the ion exchange container, in particular the ion exchange medium. With the compression device, the ion exchange container with this ion exchange medium contained therein can be compressed so that the formation of preferred fluid flow channels is counteracted. In the ion exchange chamber, on a lid of an exchange opening, through which the ion exchanger can be introduced into the ion exchange chamber, a pretensioned elastic element can be advantageously arranged with which the ion exchange container is pressed against a bottom of the ion exchange chamber and thereby is compressed. Additionally, or alternatively, an appropriate pretensioned elastic element can also be arranged at the bottom side of the ion exchange chamber and can compress the ion exchange container in the direction toward the lid. The elastic element can be in particular a spring element, in particular a coated metal spring or a plastic spring. Also, a metal spring can be provided which is arranged in a space that is sealed relative to the fluid, in particular by using a diaphragm or a bellows, in order to prevent introduction of metal ions into the fluid. A coated metal spring or a metal spring in a sealed space can advantageously be arranged at the side of the inlet of the ion exchange container. In this way, in case of damage of the coating of the metal spring or of the sealed space possibly escaping metal ions are then absorbed by the ion exchange medium that is following in the flow path and do not pass into the fluid line. Also, the compression device can comprise preferably as a part of the ion exchanger a pretensioned elastic compression envelope in which the ion exchange container is contained and that compresses the ion exchange container and, together with it, the ion exchange medium. The compression device can be a part of the ion exchanger. The lid can also be a part of the ion exchanger.

Advantageously, at least one compression device, in particular with an elastic element, can be arranged in the ion exchange container for compression of the ion exchange medium. The ion exchanger can be produced as a modular component together with the compression device. The ion exchange bag can advantageously be exchanged together with the compression device. In this context, the elastic element can be, as described above, a pretensioned spring element, in particular a coated metal spring, a plastic spring, or a metal spring in a sealed space. Since the compression device is arranged in the ion exchange container, an optimal compression of the ion exchange medium is possible since the envelope of the ion exchange container must not be deformed upon compression. The compression device can act directly onto the ion exchange medium. Accordingly, the compression device can be dimensioned to be appropriately smaller.

In a further advantageous embodiment, the envelope of the ion exchange container can be elastic at least across sections thereof. In this way, the ion exchange container can be filled tightly with the ion exchange medium so that the elastic area of the envelope is provided with pretension. This pretension compresses the contained ion exchange medium so that the elastic portion of the envelope of the ion exchange container acts as compression device. The formation of preferred flow channels is counteracted in this way. Also, by means of the elasticity of the ion exchange container, pressure fluctuations caused in the ion exchanger by the cooling fluid passing though can be compensated. Moreover, additional elastic elements for compression of the ion exchange container are not required. At least, they can be designed appropriately smaller.

Moreover, advantageously, the expansion tank can have a connection geometry for the ion exchange container with which the inlet is connected with the fluid inlet or the outlet with the fluid outlet. The connection geometry enables a simple assembly of the ion exchanger in the ion exchanger chamber. The connection geometry can be designed advantageously such that by simple insertion of the ion exchange container a fluid connection between the inlet and the fluid inlet or the outlet and the fluid outlet can be realized.

In a further advantageous embodiment, the ion exchange container can be arranged in a rigid receiving envelope, in particular an inner cylinder in the expansion tank. Due to the rigid receiving envelope, the shape of the ion exchange container can be predetermined. When using a compression device, it can be prevented in this way that the ion exchange container changes its shape and thereby suffices the compression force. Upon compression, the ion exchange container and the ion exchange medium can be pressed against an inner wall of the rigid receiving envelope so that an optimal compression of the ion exchange medium is realized. The formation of preferred flow channels can thus be counteracted in a simple and efficient way. When the receiving envelope in particular is arranged fixedly in the form of an inner cylinder within the expansion tank, it can act at the same time as a receptacle and guide for mounting the ion exchange container. The receiving envelope can be advantageously combined additionally with a connection geometry for the ion exchange container.

In a further advantageous embodiment, the ion exchanger chamber can have an exchange opening for the ion exchanger that is closeable by a lid, in particular with a snap-on connection or locking connection. By means of the exchange opening, the ion exchanger can be simply introduced into the expansion tank and removed from it. Quick release devices and looking devices can be opened and closed simply and quickly.

Advantageously, the ion exchange container can be secured by means of a holding device, in particular a two-part holding device with claws, or a locking connection on the lid. By means of the holding device the ion exchange container can be simply clamped securely and by means of the claws can be secured safely on the lid. In this way, in case of an exchange of the ion exchanger, the ion exchange container together with the lid can be separated from the expansion tank. No additional tool is required in order to engage the ion exchange container and pull it from the expansion tank. The lid can be part of the ion exchanger. The holding part can be assembled simply of two parts. It can easily be closed all the way around the ion exchange bag. The locking connection can be easily connected and released again.

Advantageously, the lid can have an opening mechanism that is at least of a two-stage configuration. In this way, a safety function can be realized in a simple way. Should there be an overpressure relative to the environment in the expansion tank, by means of the safety function it can be easily prevented that the lid when opened is thrown off in an uncontrolled fashion, which can create an endangerment of the service personnel. The opening mechanism can preferably comprises a type of bayonet closure that can be combined with a safety spring.

The technical object is solved according to the invention furthermore by the ion exchanger in that the ion exchange container has a flexible envelope. The features and advantages that have been discussed above in connection with the expansion tank according to the invention apply likewise to the ion exchanger according to the invention.

### BRIEF DESCRIPTION OF THE DRAWINGS

Further advantages, features and details of the invention may result from the following description in which embodiments of the invention will be explained in more detail with the aid of the drawing. A person skilled in the art will consider the features disclosed in combination in the drawing, the description, and the claims expediently also individually and combine them to additional meaningful combinations. It is shown schematically in:

FIG. 1 an isometric illustration of an expansion tank for cooling agent of a cooling circuit of a fuel cell system of a motor vehicle in which an ion exchanger is arranged, according to a first embodiment;

FIG. 2 a plan view of the expansion tank of FIG. 1;

FIG. 3 a side view of the expansion tank of FIGS. 1 and 2;

FIG. 4 a longitudinal section of the expansion tank of FIGS. 1 to 3 along the section line IV-IV of FIG. 2;

FIG. 5 a longitudinal section of an expansion tank according to a second embodiment which is similar to the embodiment of FIGS. 1 to 4;

FIG. 6 a longitudinal section of an expansion tank according to a third embodiment that is similar to the expansion tanks of FIGS. 1 to 5;

FIG. 7 a longitudinal section of an expansion tank according to a fourth embodiment which is similar to the expansion tanks of FIGS. 1 to 6;

FIG. 8 a side view of the ion exchanger of the expansion tank of FIG. 7;

FIG. 9 a longitudinal section of an expansion tank according to a fifth embodiment which is similar to the expansion tank of the FIGS. 1 to 8;

FIG. 10 a longitudinal section of the ion exchanger of the expansion tank of FIG. 9.

In the Figures, same components are identified with same reference characters.

### DETAILED DESCRIPTION

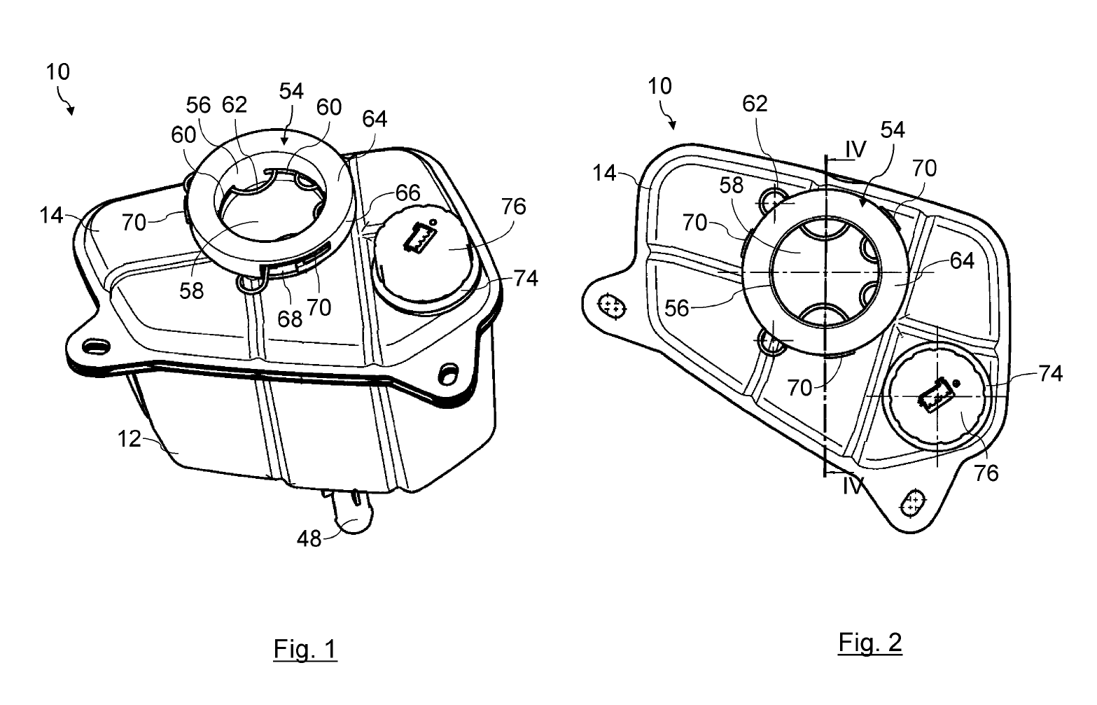

In the FIGS. 1 through 4, a first embodiment of an expansion tank 10 for cooling fluid of a cooling circuit of a fuel cell system of motor vehicle is illustrated. The expansion tank 10 comprises a bottom part 12 that is seal-tightly closed by a lid part 14.

In the expansion tank 10 surge walls 16 for the cooling fluid are arranged that divide the expansion tank 10, as illustrated in FIG. 4, into several chambers 18. The surge walls 16 act to increase strength and serve for calming the cooling fluid. The surge walls 16 each have in the lower area flow passages 20 through which the cooling fluid can flow between the chambers 18. In their upper areas, the surge walls 16 have compensation openings 22 through which, in particular for pressure compensation, air can flow between the chambers 18.

In a cylindrical receiving chamber 24 of the expansion tank 10 there is an ion exchange bag 26 of an ion exchanger referenced as a whole by reference character 25. The receiving chamber 24 is delimited by an inner cylinder 28 into which the ion exchange bag 26 is inserted. The ion exchange bag 26 is filled with a granular ion exchange material 27, indicated in FIG. 4 by cross-hatching, whose action will not be explained in more detail in this context. The inner cylinder 28 is seal-tightly connected circumferentially to the bottom of the expansion tank 10.

The bottom of the expansion tank 10 forms also a chamber bottom 30 of the receiving chamber 24. The upper rim of the inner cylinder 28 is free so that thereat connecting openings 32 to the chambers 18 of the expansion tank 10 can be realized that adjoin the inner cylinder 28.

The chamber bottom 30 is of a stepped configuration and delimits an inlet space 34 into which an inlet socket 36 extends. The chamber bottom 30 with the inlet space 34 forms in this way a connection geometry for the ion exchange bag 26. The inlet socket 36 is connected with a cooling medium line, not illustrated here, of the cooling medium circuit for supplying cooling fluid into the expansion tank 10.

A lower area, in FIG. 4, of the inlet space 34 that is facing the inlet socket 36 is reduced with respect to the diameter relative to the diameter of the inner cylinder 28. In this lower area of the inlet space 34 a pre-tensioned spiral pressure spring 38 is arranged axially to the inner cylinder 28. The spiral pressure spring 38 is of plastic material. It is supported with one end at the chamber bottom 30. With the other end, the spiral pressure spring 38 is supported on a distributor element 40.

The distributor element 40 is axially movably arranged in the inner cylinder 28. The circumferential side of the distributor element 40 is stepped. A section of the distributor element 40 facing the spiral pressure spring 38 has approximately the diameter of the lower area of the chamber bottom 38. A section of the distributor element 40 facing the ion exchange bag 26 has approximately the cross-section of the inner cylinder 28. The distributor element 40 is forced by means of the pre-tensioned spiral pressure spring 38 in axial direction against the ion exchange bag 26. In FIG. 4, the distributor element 40, for improving clarity, is illustrated in its lower position in which it does not apply a force onto the ion exchange bag 26. In the operative position, not illustrated, the pressure of the distributor element 40 against the ion exchange bag 26 has the effect that the latter is pressed into the inner cylinder 28 so that it is contacting the surface of the circumferential inner side of the inner cylinder 28. The granular ion exchange material 27 is compressed in this way so that the formation of preferred flow channels in the granular ion exchange material 27 upon passage of cooling liquid is counteracted.

The distributor element 40 has a plurality of distributor passages, indicated in FIG. 4, which connect the inlet space 34 with the adjoining bottom side of the ion exchange bag 26. By means of the distributor element 40 it is effected that the cooling fluid to be processed that is flowing through the inlet socket 36 into the inlet space 34, indicated in FIG. 4 by arrow 44, is distributed uniformly across the cross-section of the inner cylinder 28 and can flow to the bottom side of the ion exchange bag 26.

In addition to the receiving chamber 24 an outlet opening 46 is arranged in the bottom of the expansion tank 10 and is surrounded on the exterior side of the expansion tank 10 by an outlet socket 48. The outlet socket 48 is connected for removal of cooling fluid from the expansion tank 10 with an illustrated cooling medium discharge line of the cooling medium circuit.

Spatially at the top, the expansion tank 10 has on the lid part 14 a receptacle socket 50 with a receiving opening 52 that is coaxial to the inner cylinder 28 of the receiving chamber 24. Through the receiving opening 52 the ion exchange bag 26 can be introduced into the receiving chamber 24 of the expansion tank 10 and removed from it. The receptacle socket 50 widens in a funnel shape on its side that is facing away from the inner cylinder 28 so that the introduction of the ion exchange booty 26 and the installation of a receptacle lid 54 for closing the receiving opening 52 is simplified.

The receptacle lid 54 comprises a cup 56. The open side of the cup 56 is on the exterior side which is facing away from the receiving chamber 24. The receiving opening 52 is closed by a bottom 58 of the cup 56. A pressure disk 86 is resting flat against the bottom 56 of the cup 58 and is attached to the topside of the ion exchange bag 26 which is facing away from the distributor element 54.

In the circumferential wall of the cup 56, two slots 60 are extending in the circumferential direction, axially at the same level, about a portion of the circumference, respectively, and are visible in particular in FIG. 1. Curved sections of a springy securing ring 62, shown, for example, in FIGS. 1 and 2 and having configuration with multiple curves, are extending through the slots 60. The receptacle socket 50 has matching slots for the securing ring 62; these slots are not illustrated in FIGS. 1 through 4 for clarity the drawing.

At the rim of the cup 56, a collar 64 is monolithically formed. The collar 64 extends from the cup 56 radially in outward direction. It passes in radial direction outwardly into a cylinder section 66 which is coaxial to the cup 56 and in radial direction surrounds it externally. In the cylinder section 66, three approximate L-shaped bayonet receptacles 68 are arranged that each are open toward the free rim of the cylinder section 66. When the receptacle lid 54 is mounted, as shown in particular in FIG. 1, appropriate webs 70 engage the bayonet receptacle 68. The webs 70 are arranged at the radial outer circumferential side of the receptacle socket 50 and extend in the circumferential direction and in radial direction outwardly. The webs 70 and the bayonet receptacles 68 interact like a bayonet closure.

The cup 56 of the receptacle lid 54 has moreover in radial direction outwardly a circumferential sealing groove with an annular seal 72 that seals the receptacle lid 54 relative to the inner side of the receptacle socket 58 in radial direction.

By combining the webs 70 with the bayonet receptacles 68 and the securing ring 62 with the slots 60, a two-stage opening mechanism for the receptacle lid 54 is realized. After opening the bayonet closure with the webs 70 and the bayonet receptacles 68, the receptacle lid 54 is still secured by the securing ring 62 in the receptacle socket 50. In this way, it is prevented that, should there be an overpressure in the expansion tank 10 relative the environment, the receptacle lid 54 can be thrown off in an uncontrolled fashion from the receptacle socket 50. After release of the bayonet connection the receptacle lid 54 releases the receiving opening 52 so that the overpressure can be released in a controlled fashion. Only after release of the securing ring 62, the receptacle lid 54 can be removed on the receptacle socket 50.

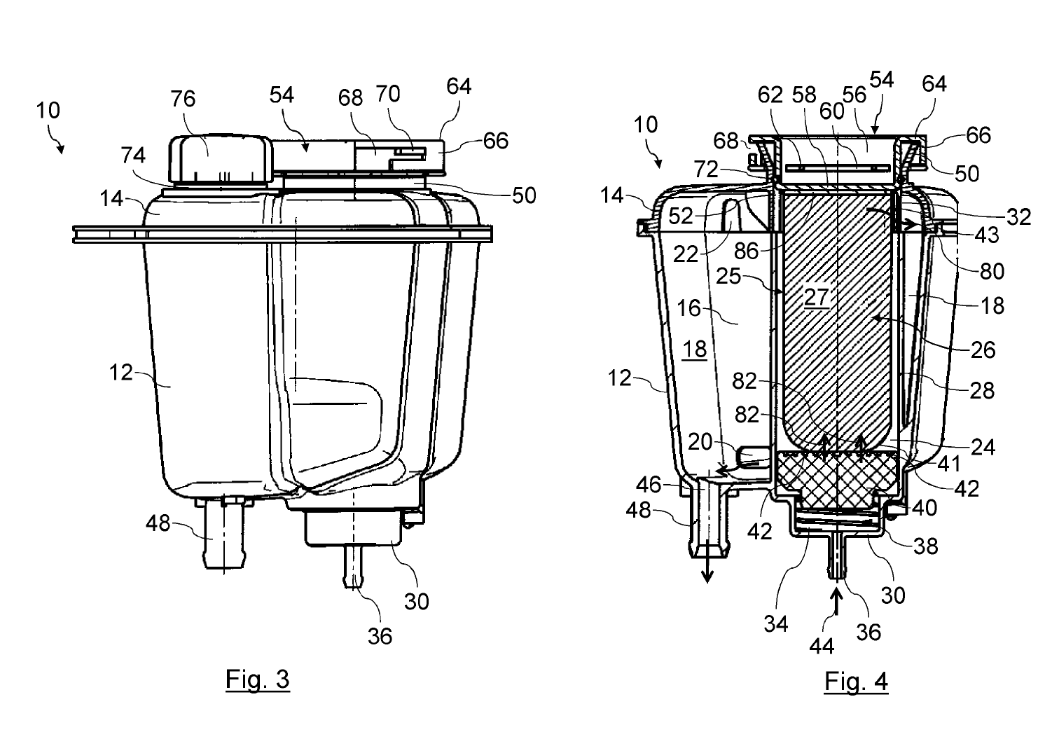

In addition to the receptacle socket 50, as illustrated in FIGS. 1 and 3, at the lid part 14 a refill socket 74 for refilling cooling fluid is arranged. The refill socket 74 is closeable by means of a screw closure 76.

The ion exchange bag 26 is made of a flexible elastic material so that it can adapt to the shape of the inner cylinder 28. The material of the ion exchange bag 26 is permeable for the cooling fluid. The cooling fluid can thus flow out of the distributor passages 42 of the distributor element 40 into the interior of the ion exchange bag 26. A section on of the ion exchange bag 26 which is facing the distributor element 40 acts in this way as an inlet 41 for the cooling fluid that is to be processed. Since the ion exchange bag 26 is resting on the inner side of inner cylinder 28, it is prevented that the cooling fluid exits thereat from the ion exchange bag 36. The cooling fluid must flow through the granular ion exchange material 27 from bottom to top in the direction of arrow 82 and is processed therein. The processed cooling fluid can flow only by means of the connecting openings 32, indicated in FIG. 4 by an arrow 80, from the receiving chamber 24. Sections of the ion exchange bag 26 provided therein serve as outlets 43 for the processed cooling fluid. The flow of the cooling fluid through the ion exchange bag 26 from the inlet 41 to the outlet 43 is thus predefined. The cooling fluid that has been processed flows out of the outlet 43 into the chambers 18 and from there through the outlet opening 46 and the outlet socket 48 out of the expansion tank 10. The material of the ion exchange bag 26 in the areas of the inlet 41 and the outlet 43 fulfills additionally a retaining function for the granular ion exchange material 27. Separate retaining devices, for example in the form of screens, are thus not required.

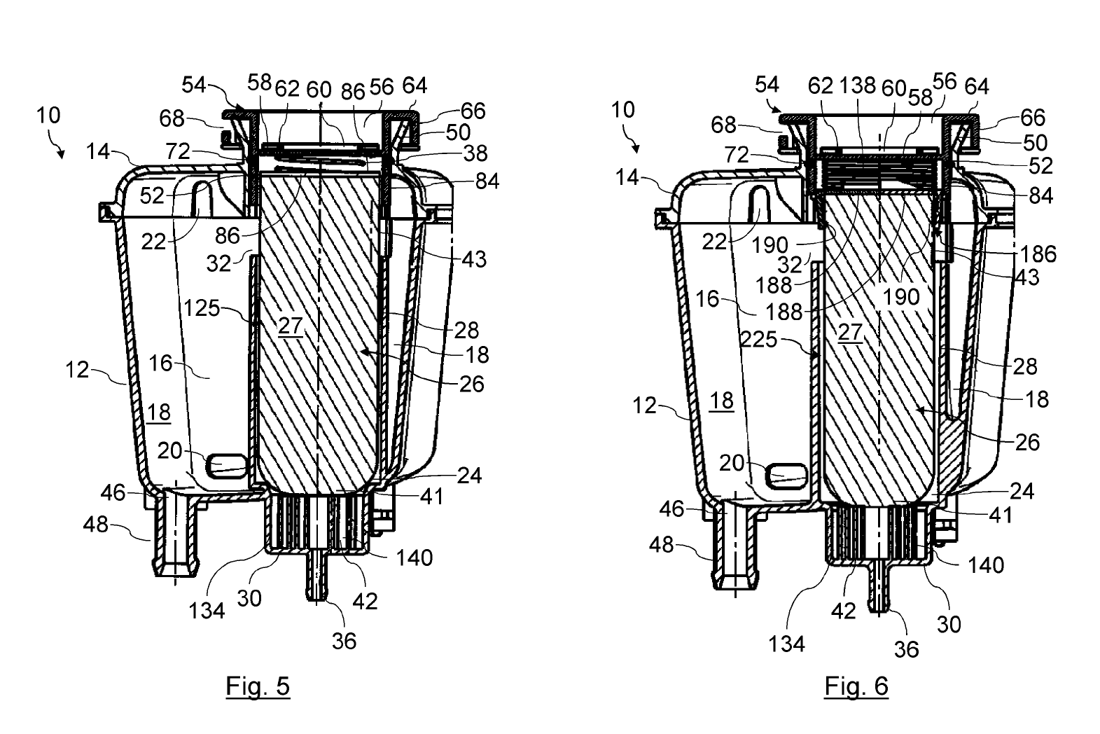

In FIG. 5, a second embodiment of the expansion tank 10 is illustrated. Those elements that are similar to those of the first embodiment of FIGS. 1 through 4 are provided with the same reference characters, with 100 being added. The second embodiment differs from the first embodiment in that the spiral pressure spring 38 is not arranged in the inlet space 34 but in a spring receiving cylinder 84. The spring receiving cylinder 84 is mounted coaxial to the cup 56 of the receptacle lid 54 on the side of the bottom 58 which is facing the receiving chamber 24. The spiral pressure spring 38 is supported with one end at the bottom 58 and at the other end on the pressure disk 86. The pressure disk 86 is movable in axial direction in the inner cylinder 28 so that the ion exchange bag 26 is compressed in the inner cylinder 28 by the pretension of the spiral pressure spring 38 by means of the pressure disk 86.

In contrast to the first embodiment, the inlet space 134 and the distributor element 140 are not stepped. The distributor element 140 is arranged to be immobile within the inlet space 134. It is acting thus as an abutment for the ion exchange bag 26.

A third embodiment, illustrated in FIG. 6, differs from the second embodiment of FIG. 5 in that instead of the pressure disk 86 a plastic cup 186 is provided. The plastic cup 186 is comprised of two separable half shells 188 which surround the ion exchange bag 26 on its side facing the receptacle lid 54. The half shells 188 have claws 190 in radial direction inwardly at their circumferential sides which claw the ion exchange bag 26 and secure it. The plastic cup 186 is movable axially in the spring receiving cylinder 84. Instead of the spiral pressure spring 38, a spring bottom 138 is provided which is attached to the bottom 58 of the cup 56 of the receptacle lid 54. The error bottom 138 presses in axial direction against the plastic cup 186 so that the ion exchange bag 26 is forced against the inner cylinder 28 and the distributor element 140 and the granular ion exchange material 27 is thus compressed.

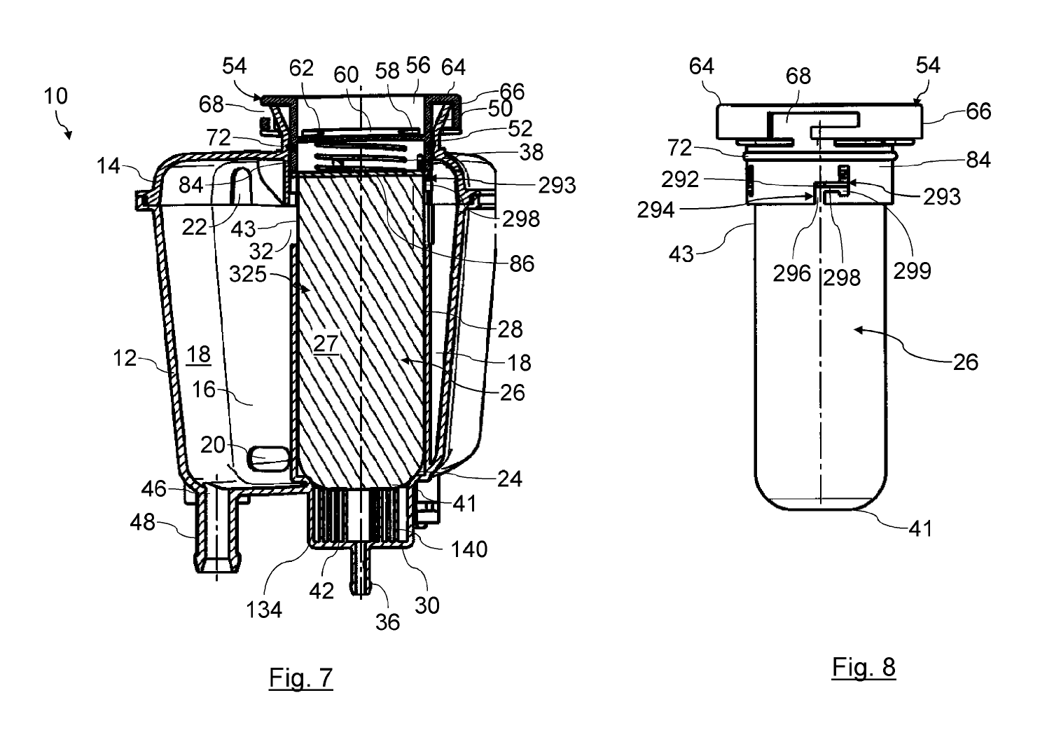

In FIGS. 7 and 8, a fourth embodiment of the expansion tank 10 is illustrated. The fourth embodiment differs from the second embodiment according to FIG. 5 in that the pressure disk 86 has, in radial direction outwardly, locking noses 292 of a locking connection 293. By means of the locking connection 293 the ion exchange bag 26 is connected in a separable way to be receptacle lid 54. The spring receiving cylinder 84 has on its circumferential wall locking recesses 294 corresponding with the locking noses 292. The locking recesses 294 each have an axially extending insertion section 296 which is open toward the free edge of the spring receptacle cylinder 84. By means of the insertion section 296, the appropriate locking nose 292 can be inserted in axial direction into the locking receptacle 294 and pulled out of it. The insertion section 296 has a transition into a translation section 298 that extends in the circumferential direction. The translation section 298 is adjoined by a displacement section 299 extending in axial direction. The displacement section 299 projects past the translation section 298 in axial direction at both sides. The locking noses 292 with the specially designed locking receptacles 294 act as securing locking means preventing that the connection between the pressure disk 86 and the receptacle lid 54 can be accidentally released. In the displacement section 292 the pressure disk 86 can move in axial direction relative to the spring receiving cylinder 84 in order to compress the ion exchange bag 26.

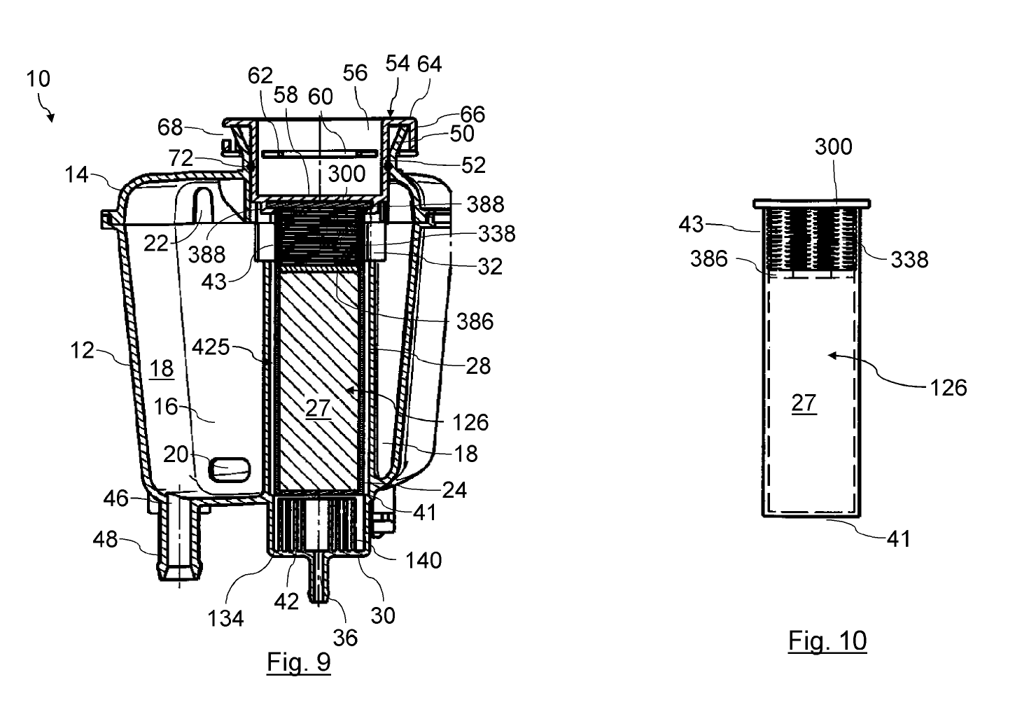

In FIGS. 9 and 10, a fifth embodiment of the expansion tank 10 is illustrated. In contrast to the second embodiment in FIG. 5, instead of the spiral pressure spring 38 a spring bottom 338 is provided which is located in the ion exchange bag 26. The spring bottom 338 is supported on a cover disk 300 which is arranged at the side of the ion exchange bag 26 that is facing the receptacle lid 54. With its end face that is facing away from the cover disk 300, the error bottom 338 is resting on a pressure disk 386. The pressure disk 386 is located in the interior of the ion exchange bag 26 between the spring bottom 338 and the granular ion exchange material 27. The pressure disk 386 is fluid-permeable. The outlet 43 of the ion exchange bag 26 is located at the level of the spring bottom 138. The cover disk 300 is secured in guide bars 388 at the bottom 58 of the receptacle lid 54.

In all of the above described embodiments of an expansion tank 10 and an ion exchanger 25, the following modifications are possible inter alia:

The invention is not limited to an ion exchanger 25 of cooling devices of fuel cells of motor vehicles. Instead, it can also be employed in ion exchangers of different functional systems for processing different liquid fluids, for example, in ion exchangers for deionizing water in spark erosion machines, in stationary fuel cell applications, or for processing aqueous urea solution which is injected, for example, for oxygen reduction of nitrogen oxides into the exhaust gas flow of an internal combustion engine. Also, the invention can be used for processing drinking water, cooling water, boiler water or other types of industrial water.

The spiral pressure springs 38 instead of being made of plastic material can also be made of coated metal. Instead of the spiral pressure springs 38 also an open-pore foam can be used as an elastic element for compression of the ion exchange container 26.

Also, a metal spring can be provided which is arranged in a space that is sealed relative to the cooling fluid, for example by using a diaphragm and/or a bellows in order to prevent the introduction of metal ions into the cooling fluid.

The ion exchange bag 26, instead of being made of a flexible elastic material, can also be made of a flexible non-elastic material or of a material that is elastic only across sections thereof.

The ion exchange bag 26 can also be designed to be impermeable in sections between the inlet 41 and the outlet 43 for fluid. For example, the ion exchange bag 26 can be coated thereat in a fluid-impermeable way or can be provided with a fluid-impermeable envelope, for example, an elastic compression envelope. When the sections between the inlet 41 and the outlet 43 are fluid-impermeable, the sealing action upon contacting of the ion exchange bag 26 on the radial inner circumferential side of the inner cylinder 28 can be eliminated. When an envelope that is appropriately fluid-impermeable has a satisfactory compression action in order to compress the granular ion exchange material 21 for avoiding preferred flow channels, the compression function of the inner cylinder 28 can also be eliminated. Possibly, the inner cylinder 28 can then be entirely eliminated.

I claim:

1. An expansion tank (10) for a cooling fluid of a cooling device of a fuel cell system, comprising at least one fluid inlet (36) and at least one fluid outlet (48) for the fluid and comprising an ion exchanger (25; 125; 225; 325; 425) for processing the fluid with an ion exchange container (26; 126) that has at least one inlet (41) for fluid to be processed and at least one outlet (43) for processed fluid and in which a granular ion exchange medium (27) is arranged in the flow between the inlet (41) and the outlet (43), and the ion exchange container (26) is exchangeably arranged in the expansion tank (10) and the inlet (41) corresponds with the fluid inlet (36) and the outlet (43) with the fluid outlet (48), wherein the ion exchange container (26) comprises a flexible envelope and in that the expansion tank has at least one compression device with at least one elastic element (38; 138; 338) for compression of the ion exchange container (26) of the ion exchange medium (27).

2. Expansion tank according to claim 1, wherein at least one compression device with an elastic element (338) is arranged for compression of the ion exchange medium (27) in the ion exchange container (26).

3. Expansion tank according to claim 1, wherein the envelope of the ion exchange container (26) is elastic at least across sections thereof.

4. Expansion tank according to claim 1, wherein the expansion tank (10) has a connection geometry (30, 34; 134) for the ion exchange container (26) with which the inlet (41) is connected with the fluid inlet (36) or the outlet with fluid outlet.

5. Expansion tank according to claim 1, wherein the ion exchange container (26) is arranged in a rigid receiving envelope as an inner cylinder (28) in the expansion tank (10).

6. Expansion tank according to claim 1, wherein the expansion tank (10) has an exchange opening (52) for the ion exchanger (25; 125; 225; 325; 425) which is closeable by a lid (54) having a snap-on connection or locking connection (68, 70).

7. Expansion tank according to claim 7, wherein the ion exchange container (26) is secured by a holding device configured as a two-part holding part (186) with claws (190) or a locking connection (293), on the lid (54).

8. Expansion tank according to claim 7, wherein the lid (54) comprises an opening mechanism (68, 70, 60, 62) with at least two stages.

9. An ion exchanger (25; 125; 225; 325; 425) of an expansion tank (10) for a cooling fluid of a fuel cell system according to claim 1, comprising an ion exchange container (26) that has at least one inlet (41) for fluid to be processed and at least one outlet (43) for processed fluid and in which a granular ion exchange medium (27) is arranged in the flow between the inlet (41) and the outlet (43) and that is configured to be arranged in an expansion tank (10) in an exchangeable way such that the inlet (41) corresponds with a fluid inlet (36) of the expansion tank (10) and the outlet (43) with a fluid outlet (43) of the expansion tank (10), wherein the ion exchange container (26) has a flexible envelope and in that the expansion tank has at least one compression device, in particular with at least one elastic element (38; 138; 338), for compression of the ion exchange container (26), in particular of the ion exchange medium (27).
